(19) United States
(12) Patent Application Publication
(10) Pub. No.: US 2024/0412405 A1
(43) Pub. Date: Dec. 12, 2024

(54) UAV, CONTROL TERMINAL, SERVER, AND CONTROL METHOD

(71) Applicant: SZ DJI TECHNOLOGY CO., LTD., Shenzhen (CN)

(72) Inventors: Ding GONG, Shenzhen (CN); Zezao LU, Shenzhen (CN); Ang LIU, Shenzhen (CN)

(21) Appl. No.: 18/807,498

(22) Filed: Aug. 16, 2024

Related U.S. Application Data
(63) Continuation of application No. PCT/CN2022/082119, filed on Mar. 21, 2022.

(51) Int. Cl. G06T 7/70; G01S 13/08; G08G 5/00; H04B 7/185

(52) U.S. Cl. CPC G06T 7/70; G01S 13/08; G08G 5/0008; H04B 7/18506

(57) ABSTRACT

A control method includes obtaining sensing data output by an observation sensor of a movable platform when sensing a target object in an environment, determining a position of the target object based on the sensing data, and sending the position of the target object to another movable platform moving in the environment, or to a relay device for the relay device to send the position of the target object to the another movable platform.

### CROSS-REFERENCE TO RELATED APPLICATION

This application is a continuation of International Patent Application No. PCT/CN2022/082119, filed on Mar. 21, 2022, the entire content of which is incorporated herein by reference.

### TECHNICAL FIELD

The present disclosure generally relates to the field of electronic control technology, and, more particularly, to a control method, control method of a server, and a movable platform.

### BACKGROUND

Unmanned vehicles are widely used in surveying, accident search and rescue, equipment inspection, or mapping. In these application fields, unmanned vehicles often perform tasks independently, that is, they independently measure, photograph, track, or perform other operations on a target object they are concerned about, and the information related to the target object is not shared. However, this operation method cannot meet the needs of certain operation scenarios. For example, when a tourist is lost in a mountain, rescuers use multiple unmanned vehicles to fly over the mountain to search for the unfamiliar tourist. When one of the unmanned vehicles finds the tourist, it is often hoped that another unmanned vehicle can know the position or direction of the tourist such that another unmanned vehicle can also observe the tourist. However, at present, the relevant information of the observed target object cannot be shared with another unmanned vehicle, resulting in the inability to meet the above requirements and making the intelligence of cooperative operation of multiple unmanned vehicles on the target objects not high.

### SUMMARY

In accordance with the disclosure, there is provided a control method including obtaining sensing data output by an observation sensor of a movable platform when sensing a target object in an environment, determining a position of the target object based on the sensing data, and sending the position of the target object to another movable platform moving in the environment or to a relay device for the relay device to send the position of the target object to the another movable platform.

Also in accordance with the disclosure, there is provided a control method of a server including obtaining a position of a target object in the environment. The position of the target object is determined according to sensing data output by a movable platform in the environment sensing the target object using an observation sensor of the movable platform. The method further includes sending the position of the target object to another movable platform moving in the environment, or to a relay device to forward the position of the target object to the another movable platform through the relay device.

Also in accordance with the disclosure, there is provided a movable platform including at least one observation sensor, at least one processor, and at least one memory storing one or more instructions that, when executed by the at least one processor, cause the movable platform to obtain sensing data output by the at least one observation sensor when sensing a target object in the environment during a process of the movable platform moving in the environment, determine a position of the target object based on the sensing data, and send the position of the target object to another movable platform moving in the environment or send the position of the target object to a relay device for the relay device to send the position of the target object to the another movable platform.

### BRIEF DESCRIPTION OF THE DRAWINGS

FIG. 1 is a flowchart of a control method of a first unmanned vehicle consistent with the present disclosure.

FIG. 2 is a flowchart of a control method of a first control terminal of the first unmanned vehicle consistent with the present disclosure.

FIG. 3 is a flowchart of a control method of a server consistent with the present disclosure.

FIG. 4 is a flowchart of a control method of a second control terminal of a second unmanned vehicle consistent with the present disclosure.

FIG. 5 is a flowchart of a control method of the second unmanned vehicle consistent with the present disclosure.

FIG. 6 is a schematic structural diagram of the first unmanned vehicle consistent with the present disclosure.

FIG. 7 is a schematic structural diagram of the first control terminal of the first unmanned vehicle consistent with the present disclosure.

FIG. 8 is a schematic structural diagram of a server consistent with the present disclosure.

FIG. 9 is a schematic structural diagram of the second unmanned vehicle consistent with the present disclosure.

FIG. 10 is a schematic structural diagram of the second control terminal of the second unmanned vehicle consistent with the present disclosure.

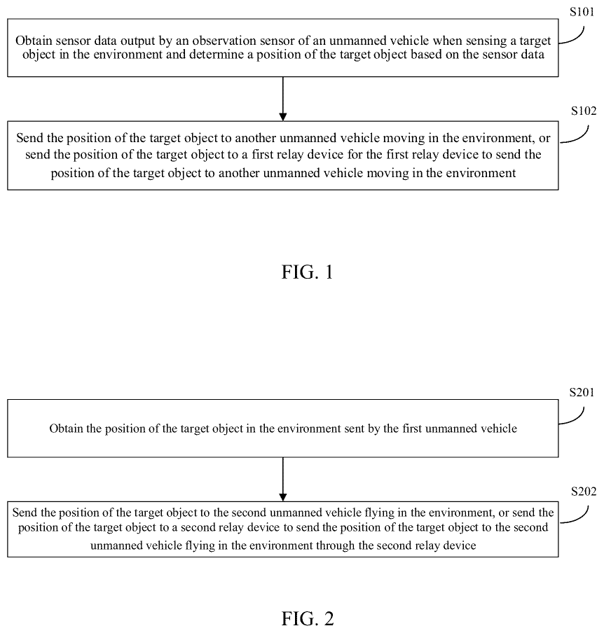

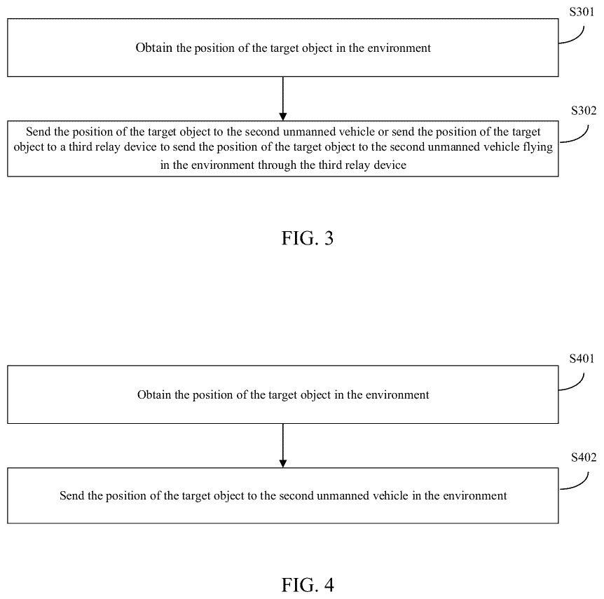

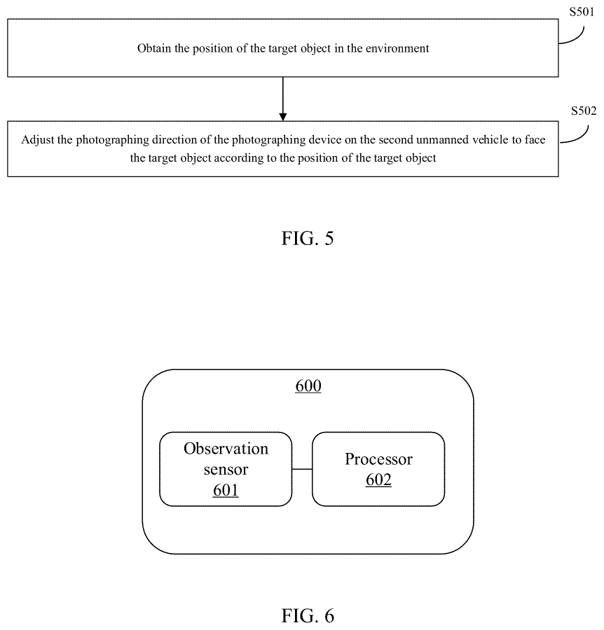

### DETAILED DESCRIPTION OF THE EMBODIMENTS

Specific embodiments of the present disclosure are hereinafter described with reference to the accompanying drawings. The same or similar reference numbers represent the same or similar elements or elements with the same or similar functions. The described embodiments are merely examples of the present disclosure, but not all of embodiments provided by the present disclosure. The described embodiments should not be regarded as limiting, but are merely examples. Those skilled in the art will envision other modifications within the scope and spirit of the present disclosure.

In the present disclosure, the terms “first” and “second” are only used for descriptive purposes and cannot be understood as indicating or implying the relative importance or implicitly indicating the quantity of the indicated technical features. Features defined as “first” and “second” may explicitly or implicitly include one or more of the described features. In the present disclosure, “plurality” means two or more, unless otherwise expressly and specifically limited.

In the present disclosure, unless otherwise clearly stated and limited, the terms “installation” or “connection” should be understood in a broad sense. For example, it may be a fixed connection, a detachable connection, or a connection in one piece. The connection may be mechanical or electrical. The connection may be a direct connection or an indirect connection through an intermediary. It can be an internal connection between two elements or an interaction between two elements. For those of ordinary skill in the art, the specific meanings of the above terms in the present disclosure can be understood according to specific circumstances.

The following disclosure provides many different embodiments or examples for implementing the various structures of the present disclosure. To simplify the description of the present disclosure, the components and arrangements of specific examples are described below. Of course, they are merely examples and are not intended to limit the scope of the present disclosure. Further, the reference numbers and/or reference letters may be repeated in different examples. Such repetition is for the purposes of simplicity and clarity and does not by itself indicate a relationship between the various embodiments and/or arrangements discussed. In addition, the present disclosure provides examples of various specific processes and materials, but those of ordinary skill in the art will recognize the application of other processes and/or the use of other materials.

The present disclosure provides a control method. The execution body of the control method may be at least one of: an unmanned vehicle, a payload of the unmanned vehicle, a control terminal, or a server. To distinguish it from another unmanned vehicle in the following text and prevent confusion, the unmanned vehicle here (i.e., the execution body of the method) may be referred to as a first unmanned vehicle, and another unmanned vehicle in the following text may be referred to as a second unmanned vehicle. The method includes S101 to S102.

At S101: during flight of the unmanned vehicle in the environment, sensing data output by an observation sensor of the unmanned vehicle sensing a target object in the environment is obtained, and a position of the target object is determined according to the sensing data.

In one embodiment, a control terminal of the unmanned vehicle here (i.e., the control terminal of the first unmanned vehicle) may be referred to as a first control terminal, and a control terminal of the another unmanned vehicle (i.e., the control terminal of the second unmanned vehicle) may be referred to as a second control terminal. The control terminal may include one or more of a remote controller, a smart phone, a tablet computer, or a wearable device. The control terminal may be wirelessly connected to the unmanned vehicle and send control instructions to the unmanned vehicle through the wireless communication connection and/or receive data sent by the unmanned vehicle through the wireless communication connection (e.g., images collected by the unmanned vehicle's photographing device, the unmanned vehicle's flight status information, or any other data). The control terminal may include an interactive device such as a joystick, a button, a wheel, or a touch panel display screen. The control terminal may detect various types of user operations described in the following text through the interactive device.

The first unmanned vehicle may include an observation sensor, and the observation sensor may include any sensor capable of outputting the sensing data such as an image, distance or position. In some embodiments, the first unmanned vehicle may include a gimbal for mounting the observation sensor and adjusting the observation direction of the observation sensor. The observation direction of the observation sensor may be determined or adjusted according to the attitude of the unmanned vehicle's body and/or the attitude of the gimbal. During the first unmanned vehicle's flight in the environment, the first unmanned vehicle may determine the position of the target object according to the sensing data (such as the image, distance or position, etc., as described above) output by the observation sensor for sensing the target object in the environment. The target object may be selected by the user of the first unmanned vehicle. Further, the target object may be selected by the user by operating the first control terminal of the first unmanned vehicle. The position of the target object may be a three-dimensional position, such as longitude, latitude and altitude. In some other embodiments, the position of the target object may be a two-dimensional position, such as longitude and latitude. The position of the target object may be represented by any position representation method disclosed in the industry. The coordinate system of the position of the target object may be a world coordinate system, a global coordinate system, a spherical coordinate system, etc.

At S102, the position of the target object is sent to another unmanned vehicle flying in the environment or the position of the target object is sent to a first relay device to make the position of the target object being sent to another unmanned vehicle flying in the environment through the first relay device, such that the another unmanned vehicle adjusts a photographing direction of a photographing device disposed at the another unmanned vehicle to the target object according to the position of the target object.

The first unmanned vehicle may send the position of the target object to another unmanned vehicle flying in the environment or send the position of the target object to the first relay device, such that the position of the target object is sent to another unmanned vehicle flying in the environment through the first relay device. As mentioned above, the another unmanned vehicle may be called a second unmanned vehicle, and the second unmanned vehicle may include a photographing device. In some embodiments, the second unmanned vehicle may include a gimbal for installing the photographing device and adjusting the photographing direction of the photographing device. Therefore, the second unmanned vehicle may be able to adjust the attitude of its body and/or the attitude of the gimbal according to the position of the target object to adjust the photographing direction of the photographing device to the target object, such that the target object appears in the photographing picture of the photographing device of the second unmanned vehicle.

In some embodiments, the first unmanned vehicle and the second unmanned vehicle may be bound to a same owner (individual, company, or organization) or workgroup. The first unmanned vehicle and the second unmanned vehicle may be bound to the same owner (individual, company, or organization) or workgroup through their respective identity information. The identity information may be any information used to distinguish an unmanned vehicle from another unmanned vehicle. For example, the identity information may include the serial number, verification code, or QR code of the unmanned vehicle. Furthermore, the first unmanned vehicle may be bound to the same owner (individual, company, or organization) or workgroup with multiple other unmanned vehicles including the second unmanned vehicle, and the second unmanned vehicle may be determined from the multiple other unmanned vehicles by the user performing an unmanned vehicle selection operation on the first control terminal. The first unmanned vehicle and the multiple other unmanned vehicles may be bound to the same owner (individual, company, or organization) or workgroup through their respective identity information.

In the unmanned vehicle control method provided by the present disclosure, the unmanned vehicle may determine the position of the target object using the observation sensor disposed at the unmanned vehicle, and the position of the target object may be transmitted to another unmanned vehicle such that the another unmanned vehicle is able to adjust the photographing direction of its photographing device to face the target object according to the position of the target object. Therefore, the another unmanned vehicle may be able to observe the target object through the photographing device, improving the intelligence of multiple unmanned vehicles in collaborative operations on the target object.

In some embodiments, the observation sensor may include a photographing device that outputs an image. Obtaining the sensing data output by the observation sensor of the unmanned vehicle sensing the target object in the environment may include: obtaining an image output by the photographing device photographing the target object in the environment. Determining the position of the target object according to the sensing data may include: determining the position of the target object in the image; and determining the position of the target object according to the position of the target object in the image.

In one embodiment, the position of the target object may be determined based on the image captured by the photographing device of the first unmanned vehicle. The first unmanned vehicle may obtain the image output by the photographing device photographing the target object in the environment, determine the position of the target object in the image, and determine the position of the target object according to the position of the target object in the image. The following embodiment provides a method for determining the position of the target object according to the position of the target object in the image. The first unmanned vehicle may determine the relative position between the target object and the first unmanned vehicle according to the position of the target object in the image and the photographing direction of the photographing device, and determine the position of the target object according to the relative position, the height of the first unmanned vehicle and the position of the first unmanned vehicle.

In some embodiments, the target object may be selected by a user when performing a target object selection operation on the control terminal of the first unmanned vehicle that displays the image captured by the photographing device. As mentioned above, the target object may be selected by the user operating the control terminal of the first unmanned vehicle. The first unmanned vehicle may send the image to the first control terminal through the wireless communication connection between the first unmanned vehicle and the first control terminal, such that the first control terminal displays the image in real time. The user may perform the target selection operation on the first control terminal to select the target object in the displayed image. The first control terminal may determine the target object indication information based on the detected target object selection operation. The target object indication information may include the position of the target object in the image. For example, the first control terminal may include a touch display, the touch display may display the image, and the user may perform a point selection operation or a frame selection operation on the touch display to select the target object in the displayed image. The first control terminal may send the target object indication information to the first unmanned vehicle, and the first unmanned vehicle may receive the target object indication information and select the target object in the environment based on the target indication information.

Determining the position of the target object in the image may include: running an image tracking algorithm on the image according to the target object indication information to obtain the position of the target object in the image. As mentioned above, the user may select the target object in a displayed frame of image, but this frame of image may be only one frame of the image output by the photographing device in real time. Since the position of the target object in the image output by the photographing device needs to be determined in real time, the first unmanned vehicle may run an image tracking algorithm on the real-time image output by the photographing device according to the target object indication information to obtain the position of the target object in the image.

The first unmanned vehicle may send the image captured by the photographing device to the control terminal of the unmanned vehicle such that the control terminal displays the image. The first control terminal may display a mark indicating the position of the target object in the image in the displayed image, such that the user know in real time which object in the image is the target object. In one embodiment, the first unmanned vehicle may send the position of the target object in the image determined in the manner described above to the first control terminal such that the first control terminal displays the mark indicating the position of the target object in the image on the displayed image. In another feasible manner, the first control terminal may execute an image tracking algorithm on the real-time image received from the first unmanned vehicle according to the indication information of the target object described above to obtain the position of the target object in the image, and display the mark indicating the position of the target object in the image on the displayed image according to the position. The mark may include at least one of text, symbols, shadows, or graphics.

In some embodiments, the observation sensor may include a ranging sensor, and obtaining the sensing data output by the observation sensor of the unmanned vehicle for sensing the target object in the environment may include: obtaining the distance to the target object output by the ranging sensor and the observation attitude of the ranging sensor; and determining the position of the target object according to the output distance to the target object and the observation attitude.

The observation sensor of the first unmanned vehicle may include a ranging sensor, wherein the ranging sensor may be various types of ranging sensors. In one embodiment, the ranging sensor may be an image-based ranging sensor, such as a binocular photographing device. In some other embodiments, the ranging sensor may be a ranging sensor based on transmitting and receiving a ranging signal. The ranging sensor may include a transceiver for transmitting a ranging signal and receiving the ranging signal reflected by the target object. The ranging signal may be a radar signal, an optical signal or a sound signal, etc., and the ranging sensor may include a laser ranging sensor, a TOF sensor or various types of radars. The first unmanned vehicle may obtain the distance to the target object output by the ranging sensor, and further, the first unmanned vehicle may obtain the observation attitude of the ranging sensor. As mentioned above, the observation direction of the observation sensor may be determined according to the attitude of the body of the unmanned vehicle and/or the attitude of the gimbal on which the observation sensor is installed, and the observation direction of the ranging sensor may be determined according to the attitude of the body of the first unmanned vehicle and/or the attitude of the gimbal. The first unmanned vehicle may determine the position of the target object according to the distance to the target object output by the ranging sensor and the observation direction. Further, the first unmanned vehicle may determine the position of the target object according to the distance to the target object output by the ranging sensor, the observation direction and the position of the first unmanned vehicle. The position of the first unmanned vehicle may be obtained by a satellite positioning device of the first unmanned vehicle.

The target object may be selected by the user through the operation of the control terminal of the first unmanned vehicle. In one embodiment, as an implementation method of selecting the target object by the user through the operation of the control terminal of the first unmanned vehicle, the operation performed by the user on the control terminal of the first unmanned vehicle may include the observation direction adjustment operation performed by the user on the first control terminal. The first control terminal may detect the observation direction adjustment operation of the user, and generate the observation direction adjustment instruction of the ranging sensor according to the detected observation direction adjustment operation. The observation direction adjustment instruction may be used to adjust the observation direction of the ranging sensor of the first unmanned vehicle. For example, the first control terminal and/or the second control terminal may include an interactive device such as an operating rod, a button, a wheel or a touch panel display screen, and the observation direction adjustment operation may be performed on the interactive device. The first control terminal may detect the observation direction adjustment operation of the user through the interactive device. The first control terminal may send the observation direction adjustment instruction to the first unmanned vehicle, and the first unmanned vehicle may adjust the observation direction of the ranging sensor to face the target object according to the observation direction adjustment instruction. The first unmanned vehicle may adjust the attitude of the body of the first unmanned vehicle and/or the attitude of the gimbal on which the ranging sensor is installed according to the observation direction adjustment instruction to adjust the observation direction of the ranging sensor to face the target object.

The first unmanned vehicle may send the image captured by the photographing device to the control terminal of the unmanned vehicle such that the control terminal displays the image. In the scenario where the position of the target object is determined according to the ranging sensor, to help the user understand which object in the image displayed on the first control terminal is the target object, the first unmanned vehicle may determine the position of the target object in the image according to the position of the target object, and send the position of the target object in the image to the first control terminal of the first unmanned vehicle, such that the first control terminal displays the mark indicating the position of the target object in the image on the displayed image according to the position of the target object in the image. Further, the first unmanned vehicle may determine the position of the target object in the image captured by the photographing device according to the relative position relationship between the ranging sensor and the photographing device and the position of the target object. Alternatively, the first unmanned vehicle may send the position of the target object to the first control terminal of the first unmanned vehicle, and the first control terminal may determine the position of the target object in the image according to the position of the target object and display the mark indicating the position of the target object in the image on the displayed image. Further, the first control terminal may determine the position of the target object in the image captured by the photographing device according to the relative position relationship between the ranging sensor and the photographing device and the position of the target object. As mentioned above, the mark may include one or more of text, symbols, shadow, or graphics. In some embodiments, the ranging sensor and the photographing device may be fixedly installed, and the relative positional relationship between the ranging sensor and the photographing device may be fixed. The ranging sensor and the photographing device may be fixedly installed on the gimbal, and the observation direction of the ranging sensor may be parallel to the photographing direction of the photographing device. In some other embodiments, the ranging sensor and the photographing device may be movably installed, and the relative positional relationship between the ranging sensor and the photographing device may be determined in real time.

In some embodiments, the first relay device may include at least one of the first control terminal of the first unmanned vehicle, a server, or the second control terminal of the second unmanned vehicle. The first unmanned vehicle may send the position of the target object to the second unmanned vehicle flying in the environment or send the position of the target object to the first relay device such that the position of the target object is sent to the second unmanned vehicle flying in the environment through the first relay device. In some embodiments, the first unmanned vehicle may establish a wireless communication connection with the second unmanned vehicle, and the first unmanned vehicle may send the position of the target object to the second unmanned vehicle through the wireless communication connection. In some other embodiments, the first unmanned vehicle may send the position of the target object to the first relay device, and the first relay device may establish a direct or indirect wireless communication connection with the second unmanned vehicle and send the position of the target object to the second unmanned vehicle through the direct or indirect wireless communication connection. For example, in one embodiment, the first relay device may include the first control terminal, the first unmanned vehicle may send the position of the target object to the first control terminal. In another embodiment, the first control terminal may send the position of the target object to the server, the server may send the position of the target object to the second control terminal, and the second control terminal may send the position of the target object to the second unmanned vehicle through the wireless communication connection between the second control terminal and the second unmanned vehicle. In another embodiment, the server may send the position of the target object received from the first control terminal to the second unmanned vehicle. In another embodiment, the first control terminal may send the position of the target object to the second unmanned vehicle or send the position of the target object to the second control terminal such that the second control terminal sends the position of the target object to the second unmanned vehicle. In another embodiment, the first relay device may include a server, the first unmanned vehicle may send the position of the target object to the server, the server may send the position of the target object to the second control terminal, and the second control terminal may send the position of the target object to the second unmanned vehicle through the wireless communication connection between the second control terminal and the second unmanned vehicle. The server may send the position of the target object received from the first control terminal to the second unmanned vehicle. For another example, the first relay device may include the second control terminal, the first unmanned vehicle may send the position of the target object to the second control terminal, and the second control terminal may send the position of the target object to the second unmanned vehicle.

In some embodiments, the position of the target object may be sent to the second unmanned vehicle flying in the environment such that the second unmanned vehicle controls the zoom of the photographing device according to the position of the target object; and/or, the position of the target object may be sent to the second unmanned vehicle flying in the environment such that the second unmanned vehicle tracks the target object according to the position of the target object.

In some embodiments, the position of the target object may be sent to the second unmanned vehicle in the manner described above, and the second unmanned vehicle may control the zooming of the lens of the photographing device according to the position of the target object to adjust the size of the target object in the photographing picture of the photographing device. In some other embodiments, the position of the target object may be sent to the second unmanned vehicle in the manner described above, and the second unmanned vehicle may track the target object according to the position of the target object. Further, the second unmanned vehicle may determine whether a preset tracking condition is met. When the preset tracking condition is met, the second unmanned vehicle may track the target object according to the position of the target object. Further, the second unmanned vehicle may track the target object according to the position of the target object and the position of the second unmanned vehicle, and the position of the second unmanned vehicle may be collected by the satellite positioning device of the second unmanned vehicle. The preset tracking condition may include at least one of the remaining power of the second unmanned vehicle being greater than or equal to a preset power threshold, the distance between the second unmanned vehicle and the first unmanned vehicle or the target object being less than or equal to a preset distance threshold, or the second unmanned vehicle being in flight. The first unmanned vehicle can transmit the position of the first unmanned vehicle to the second unmanned vehicle in the same manner as the position of the target object, the second unmanned vehicle may determine the distance between the second unmanned vehicle and the first unmanned vehicle according to the position of the first unmanned vehicle, and the first unmanned vehicle may determine the distance to the target object according to the position of the target object. The second unmanned vehicle may first fly to a preset height, and then track the target object according to the position of the target object. The first unmanned vehicle may determine the position of the target object in real time in the manner described above, the position of the target object may be transmitted to the second unmanned vehicle in real time in the manner described above, and the second unmanned vehicle may track the target object according to the position of the target object received in real time. In some embodiments, the target object may be a tracking object of the first unmanned vehicle, that is, the first unmanned vehicle may track the target object. In some embodiments, the first unmanned vehicle may determine the speed of the target object according to the sensing data output by the observation sensor, the first unmanned vehicle may transmit the speed of the target object to the second unmanned vehicle in the same manner as the position of the target object, and the second unmanned vehicle may track the target object according to the speed and position of the target object. The speed of the target object may be determined according to the position of the target object. The speed of the target object may be determined in real time by the first unmanned vehicle and transmitted to the second unmanned vehicle in real time.

The present disclosure also provides a control method of a control terminal corresponding to an unmanned vehicle. The control terminal may communicate with the unmanned vehicle. The execution body of the method may be a control terminal corresponding to an unmanned vehicle, and the control terminal of the unmanned vehicle here may be the control terminal of the first unmanned vehicle as mentioned above, that is, the first control terminal as mentioned above. The method may include:
S201: obtaining the position of the target object during flight of the first unmanned vehicle in the environment sent by the first unmanned vehicle, where the position of the target object is determined according to the sensing data output by the first unmanned vehicle sensing the target object through the observation sensor on the first unmanned vehicle; and
S202: sending the position of the target object to the second unmanned vehicle flying in the environment, or sending the position of the target object to a second relay device to send the position of the target object to the second unmanned vehicle flying in the environment through the second relay device, such that the second unmanned vehicle adjusts the photographing direction of the photographing device on the second unmanned vehicle to face the target object according to the position of the target object.

In some embodiments, the first control terminal may display a map of the environment, the first control terminal may detect a user's location point selection operation (i.e., an operation to select a location point) on the displayed map, determine the position of the location point selected by the user on the map according to the detected location point selection operation, and send the position of the location point to the second unmanned vehicle flying in the environment or send the position of the location point to the second relay device, such that the second unmanned vehicle adjusts the photographing direction of the photographing device on the second unmanned vehicle to the position facing the location point according to the position of the location point. Further, the first control terminal may include a touch display, and the touch display may display the map. The user may perform a point selection operation on the touch display screen displaying the map, and the first control terminal may determine the position of the location point selected by the user on the map through the point selection operation detected by the touch display screen. The way for the first control terminal to send the position of the location point to the second unmanned vehicle may be the same as the way for the first control terminal to send the position of the target object to the second unmanned vehicle, and the details are not repeated.

Therefore, the position of the target object may be transmitted to the second unmanned vehicle flying in the environment such that the second unmanned vehicle adjusts the photographing direction of the photographing device on the second unmanned vehicle to the target object according to the orientation or position of the target object.

In some embodiments, the observation sensor may include a photographing device. The first control terminal may receive and display the image captured by the photographing device sent by the first unmanned vehicle, detect the user's target object selection operation on the displayed image, and determine the target object indication information according to the detected target object selection operation. The target object indication information may include the position of the target object in the image. The target object indication information may be sent to the first unmanned vehicle such that the first unmanned vehicle selects the target object in the environment.

In some embodiments, the first control terminal may display a mark indicating the position of the target object in the image on the displayed image. The first control terminal may display the mark in two ways as described above. In one way, the first control terminal may receive the position of the target object in the image sent by the unmanned vehicle, and display the mark indicating the position of the target object in the image on the displayed image according to the position of the target object in the image. In another way, the first control terminal may run an image tracking algorithm on the image received from the first unmanned vehicle according to the target object indication information as described above to obtain the position of the target object in the image, and display the mark indicating the position of the target object in the image in the displayed image according to the position of the target object in the image.

In some embodiments, the observation sensor may include a ranging sensor, and the first unmanned vehicle may include a gimbal for installing the ranging sensor and adjusting the observation direction of the ranging sensor. The first control terminal may detect the user's observation direction adjustment operation, generate an observation direction adjustment instruction according to the detected observation direction adjustment operation, and send the observation direction adjustment instruction to the first unmanned vehicle, such that the first unmanned vehicle adjusts the observation direction of the ranging sensor to the target object according to the observation direction adjustment instruction.

In some embodiments, the first unmanned vehicle may include a photographing device. The first control terminal may receive and display the image captured by the photographing device sent by the first unmanned vehicle. The first control terminal may receive the position of the target object in the image sent by the first unmanned vehicle, and display a mark indicating the position of the target object in the image on the displayed image. The position of the target object in the image may be determined by the first unmanned vehicle according to the position of the target object. In another embodiment, the first control terminal may determine the position of the target object in the image according to the position of the target object, and display a mark indicating the position of the target object in the image on the displayed image.

In some embodiments, the second relay device may include at least one of the server as described above or the second control terminal of the second unmanned vehicle as described above.

In some embodiments, the second unmanned vehicle may be determined by the user performing an unmanned vehicle selection operation on the first control terminal. For example, the first control terminal may display the indication information of multiple candidate unmanned vehicles, detect the unmanned vehicle selection operation of the user, and determine the indication information of the unmanned vehicle selected by the user from the identity information of the multiple candidate unmanned vehicles according to the detected unmanned vehicle selection operation. The first control terminal may display the indication information of the multiple candidate unmanned vehicles. For example, the touch display of the first control terminal may display the indication information of the multiple candidate unmanned vehicles. The indication information of an unmanned vehicle may include at least one of the identity information of the unmanned vehicle as described above, the identity information of the user of the unmanned vehicle (such as ID number, user name, name, nickname, etc.), or the location of the unmanned vehicle. The multiple candidate unmanned vehicles may be unmanned vehicles whose distance from the first unmanned vehicle is less than or equal to a preset distance threshold. The multiple candidate unmanned vehicles may be other multiple unmanned vehicles that are bound to the same owner (individual, company, or organization) or work group as the first unmanned vehicle as described above. The first control terminal may detect the user's unmanned vehicle selection operation through the interaction device as described above, determine the indication information of the unmanned vehicle selected by the user from the indication information of the multiple candidate unmanned vehicles (i.e., the indication information of the second unmanned vehicle) according to the detected unmanned vehicle selection operation, and send the position of the target object to the second unmanned vehicle corresponding to the selected indication information flying in the environment or send the position of the target object to the second relay device, such that the position of the target object is sent to the second unmanned vehicle corresponding to the selected indication information and flying in the environment through the second relay device.

In some embodiments, the position of the target object may be transmitted to the second unmanned vehicle flying in the environment such that the second unmanned vehicle controls the zoom of the photographing device according to the position of the target object; and/or, the position of the target object may be transmitted to the second unmanned vehicle flying in the environment such that the second unmanned vehicle tracks the target object according to the position of the target object.

The present disclosure also provides a control method of a server. The execution body of the method may be the server described above. The method may include S301 and S302.

At S301, the position of the target object in the environment is obtained. The position of the target object may be determined according to the sensing data output by the first unmanned vehicle in the environment sensing the target object through the observation sensor on the first unmanned vehicle.

In one embodiment, the server may obtain the position of the target object in the environment. As described above, the server may obtain the position of the target object sent by the first unmanned vehicle, or the server may obtain the position of the target object sent by the control terminal of the first unmanned vehicle.

At S302, the position of the target object is sent to the second unmanned vehicle or the position of the target object is sent to a third relay device to send the position of the target object to the second unmanned vehicle flying in the environment through the third relay device, such that the second unmanned vehicle adjusts the photographing direction of the photographing device on the second unmanned vehicle to face the target object according to the position of the target object.

In one embodiment, the server may send the position of the target object to the second unmanned vehicle. In another embodiment, the server may send the position of the target object to the third relay device, where the third relay device may include the second control terminal of the second unmanned vehicle as described above, such that the second control terminal sends the position of the target to the second unmanned vehicle.

In some embodiments, as described above, the first unmanned vehicle and the second unmanned vehicle may be bound to the same owner (individual, company, or organization) or workgroup, and the server may determine the second unmanned vehicle that is bound to the owner (individual, company, or organization) or workgroup same as the first unmanned vehicle. The server may send the position of the target object to the bound second unmanned vehicle or send the position of the target object to the third relay device to make the third delay device send the position of the target object to the bound second unmanned vehicle flying in the environment.

The first unmanned vehicle and the second unmanned vehicle may be bound by their respective identity information (i.e., the identity information of the first unmanned vehicle and the identity information of the second unmanned vehicle), and the server may obtain the identity information of the first unmanned vehicle, and determine the second unmanned vehicle bound to the first unmanned vehicle according to the identity information of the first unmanned vehicle. The way in which the server obtains the identity information of the first unmanned vehicle may be the same as the way in which the server obtains the position of the target object in the environment.

In some embodiments, the server may determine the another unmanned vehicle in the environment from multiple candidate unmanned vehicles, and the server may select the another unmanned vehicle from the multiple candidate unmanned vehicles based on the user's unmanned vehicle selection operation.

In some embodiments, the position of the target object may be sent to the multiple candidate unmanned vehicles or the position of the target object may be sent to the third relay device to make the third relay device send the position of the target object sent to the multiple candidate unmanned vehicles flying in the environment, such that the multiple candidate unmanned vehicles adjust the photographing direction of the photographing devices on the multiple candidate unmanned vehicles to face the target object according to the position of the target object, where the multiple candidate unmanned vehicles include the another unmanned vehicle.

The multiple candidate unmanned vehicles may be unmanned vehicles whose distance from the first unmanned vehicle is less than or equal to a preset distance threshold. In some other embodiments, the multiple candidate unmanned vehicles may be other multiple unmanned vehicles bound to the same owner (individual, company, or organization) or working group as the first unmanned vehicle as mentioned above.

The present disclosure also provides a control method of a control terminal corresponding to an unmanned vehicle. The execution body of the method may be the control terminal of the unmanned vehicle. The control terminal of the unmanned vehicle may be the control terminal of the second unmanned vehicle mentioned above, that is, the second control terminal mentioned above. The method includes S401 and S402.

At S401, the position of the target object in the environment is obtained. The position of the target object may be determined according to the sensing data output by the first unmanned vehicle in the environment sensing the target object through the observation sensor on the first unmanned vehicle.

The second control terminal may obtain the position of the target object in the environment. The second control terminal may obtain the position of the target object sent by the first unmanned vehicle, or the second control terminal may obtain the position of the target object sent by the control terminal of the first unmanned vehicle, or the second control terminal may obtain the position of the target object sent by the server.

At S402, the position of the target object is sent to the second unmanned vehicle in the environment, such that the second unmanned vehicle adjusts the photographing direction of the photographing device on the second unmanned vehicle to face the target object according to the position of the target object.

In some embodiments, the second control terminal may display the mark indicating the position of the target object according to the position of the target object in response to obtaining the position of the target object; and/or, the second control terminal may display the mark indicating the orientation of the target object according to the position of the target object in response to obtaining the position of the target object, such that the user of the second unmanned vehicle may easily understand the position or orientation of the target object. Further, the second control terminal may display the mark indicating the position of the target object according to the position of the target object and the position of the unmanned vehicle, and/or, the second control terminal may display the mark indicating the orientation of the target object according to the position of the second unmanned vehicle and the position of the target object.

In some embodiments, the second control terminal may obtain and display the indication information of the first unmanned vehicle, such that the user may understand the relevant information of the unmanned vehicle that observes the position of the target object. The second control terminal may obtain the indication information of the first unmanned vehicle. As mentioned above, the indication information of the unmanned vehicle may include at least one of the identity information of the unmanned vehicle, the identity information of the user of the unmanned vehicle (such as ID number, user name, name, nickname, etc.), or the location of the unmanned vehicle. The second control terminal may obtain the indication information of the first unmanned vehicle in the same manner as obtaining the position of the target object.

In some embodiments, in response to obtaining the position of the target object, the second control terminal may display prompt information of obtaining the position of the target object. The prompt information may include the indication information of the first unmanned vehicle obtained by the second control terminal as mentioned above.

In some embodiments, the second control terminal may determine whether a preset sending condition is met in response to obtaining the position of the target object, and send the obtained position of the target object to the second unmanned vehicle when the preset sending position is met. When the preset sending condition is not met, the second control terminal may refuse to send the position of the target object to the second unmanned vehicle. In some cases, when the preset sending condition is not met, a prompt message of refusing to send may be displayed.

In some embodiments, when the second control terminal determines whether the preset sending condition is met, the second control terminal may determine whether the user's permission response operation is detected. When the permission response operation is detected, it may be determined that the preset sending condition is met. When the permission response operation is not detected, it may be determined that the preset sending condition is not met.

In some embodiments, when the second control terminal determines whether the preset sending condition is met, the second control terminal may determine whether the second unmanned vehicle meets a preset response condition. The preset response condition may include at least one of whether the remaining power of the second unmanned vehicle is greater than or equal to the preset power threshold, whether the distance between the second unmanned vehicle and the first unmanned vehicle or the target object is less than or equal to the preset distance threshold, or whether the second unmanned vehicle is in a flight state. When it is determined that the second unmanned vehicle meets the preset response condition, it may be determined that the preset sending condition is met. When the second unmanned vehicle does not meet the preset response condition, it may be determined that the preset sending condition is not met.

In some embodiments, the second control terminal may obtain an image captured by the camera of the second unmanned vehicle, display the image, and display the mark indicating the position of the target object in the image in the displayed image. As the photographing direction of the camera of the second unmanned vehicle is adjusted to face the target object, the target object may appear in the photographing picture of the camera of the second unmanned vehicle. To facilitate the user of the second unmanned vehicle to understand which object in the image displayed by the second control terminal is the target object, the second control terminal may display the mark indicating the position of the target object in the image in the displayed image. Further, the second control terminal may obtain the position of the target object in the image, and display the mark indicating the position of the target object in the image in the displayed image according to the position of the target object in the image. The position of the target object in the image captured by the camera of the second unmanned vehicle may be determined according to the position of the target object and the photographing direction of the camera of the second unmanned vehicle. The second control terminal may obtain the position of the target object in the image, which may include that the second control terminal obtains the position of the target object in the image sent by the second unmanned vehicle, and the position of the target object in the image captured by the camera of the second unmanned vehicle may be determined by the second unmanned vehicle according to the position of the target object and the photographing direction of the camera of the second unmanned vehicle. In some embodiments, the second control terminal may obtain the position of the target object in the image, which may include that the second control terminal determines the position of the target object in the image captured by the photographing device of the second unmanned vehicle based on the position of the target object and the photographing direction of the photographing device of the second unmanned vehicle. The photographing direction of the photographing device of the second unmanned vehicle may be obtained from the second unmanned vehicle.

The present disclosure also provides a control method of an unmanned vehicle. The execution body of the method may be an unmanned vehicle, and the unmanned vehicle may be the second unmanned vehicle mentioned above. The unmanned vehicle may include a photographing device. The method may include S501 and S502.

At S501, the position of the target object in the environment is obtained. The position of the target object may be determined according to the sensing data output by the first unmanned vehicle in the environment sensing the target object through the observation sensor on the first unmanned vehicle.

The second unmanned vehicle may obtain the position of the target object in the environment. The second unmanned vehicle may obtain the position of the target object sent by the first unmanned vehicle, or the second unmanned vehicle may obtain the position of the target object sent by the first control terminal of the first unmanned vehicle, or the second unmanned vehicle may obtain the position of the target object sent by the second control terminal of the second unmanned vehicle, or the second control terminal may obtain the position of the target object sent by the server.

At S502, the second unmanned vehicle adjusts the photographing direction of the photographing device on the second unmanned vehicle to face the target object according to the position of the target object. Specifically, the second unmanned vehicle may adjust the photographing direction of the photographing device to face the target object by adjusting the attitude of the body and/or the gimbal on which the photographing device is installed.

In some embodiments, the second unmanned vehicle may track the target object according to the position of the target object.

For the details of the control method of the second unmanned vehicle, the reference may be made to previous descriptions.

The present disclosure also provides an unmanned vehicle 600, as shown in FIG. 6. In one embodiment, the unmanned vehicle 600 may be the first unmanned vehicle mentioned above, and may include an observation sensor 601 and a processor 602.

The processor 602 may be configured to:
during the process of the unmanned vehicle flying in the environment, the sensing data output by the unmanned vehicle's observation sensor for sensing the target object in the environment, and determine the position of the target object according to the sensing data;
send the position of the target object to another unmanned vehicle flying in the environment or send the position of the target object to a first relay device to make the first relay device send the position of the target object is the another unmanned vehicle flying in the environment, such that the another unmanned vehicle adjusts the photographing direction of the photographing device on the another unmanned vehicle to face the target object according to the position of the target object.

In some embodiments, the observation sensor may include a photographing device, and the at least one processor may be configured to:
obtain an image output by the photographing device for photographing the target object in the environment;
determine the position of the target object in the image; and
determine the position of the target object according to the position of the target object in the image.

In some embodiments, the target object may be selected by the user when performing a target object selection operation on the control terminal of the unmanned vehicle that displays the image collected by the photographing device.

In some embodiments, the at least one processor may be configured to:
send the image captured by the photographing device to the control terminal of the unmanned vehicle such that the control terminal displays the image; and
send the determined position of the target object in the image to the control terminal of the unmanned vehicle such that the control terminal displays a mark indicating the position of the target object in the image on the displayed image.

In some embodiments, the observation sensor may include a ranging sensor, and the at least one processor may be configured to:
obtain the distance to the target object output by the ranging sensor and the observation attitude of the ranging sensor; and
determine the position of the target object according to the output distance to the target object and the observation attitude.

In some embodiments, the ranging sensor may include a transceiver for transmitting a ranging signal and receiving a ranging signal reflected by the target object.

In some embodiments, the unmanned vehicle may include a gimbal for installing the ranging sensor and adjusting the observation direction of the ranging sensor, and the at least one processor may be configured to:
obtain an observation direction adjustment instruction sent by the control terminal of the unmanned vehicle; and
control the gimbal to adjust the observation direction of the ranging sensor according to the observation direction adjustment instruction such that the observation direction faces the target object.

In some embodiments, the unmanned vehicle may include a photographing device, and the at least one processor may be configured to:
send the image captured by the photographing device to the control terminal of the unmanned vehicle such that the control terminal displays the image;
determine the position of the target object in the image according to the position of the target object, and send the position of the target object in the image to the control terminal of the unmanned vehicle such that the control terminal displays a mark indicating the position of the target object in the image on the displayed image; or,
send the position of the target object to the control terminal of the unmanned vehicle such that the control terminal determines the position of the target object in the image according to the position of the target object and displays the mark indicating the position of the target object in the image on the displayed image.

In some embodiments, the first relay device may include at least one of the control terminal of the unmanned vehicle, the server, or the control terminal of the another unmanned vehicle.

In some embodiments, the position of the target object may be transmitted to the another unmanned vehicle flying in the environment such that the another unmanned vehicle controls the zoom of the photographing device according to the position of the target object; and/or,
the position of the target object may be transmitted to the another unmanned vehicle flying in the environment such that the another unmanned vehicle tracks the target object according to the position of the target object.

In some embodiments, the unmanned vehicle and the another unmanned vehicle may be unmanned vehicles bound to the same owner or workgroup.

In some embodiments, the target object may be selected by the user performing a target object selection operation on the control terminal of the unmanned vehicle.

In some embodiments, the unmanned vehicle 600 may include at least one processor and at least one memory storing one or more instructions that, when executed by the at least one processor, causes the unmanned vehicle 600 to perform a method consistent with the disclosure.

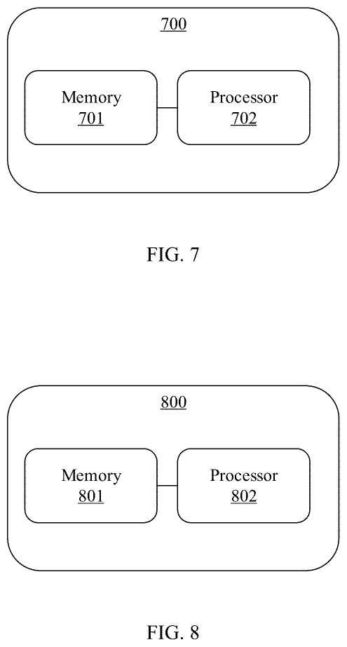

As shown in FIG. 7, the present disclosure also provides a control terminal 700 of an unmanned vehicle. The control terminal may be the first control terminal as described above, including at least one memory 701 and at least one processor 702.

The at least one memory 701 may store one or more program codes.

The at least one processor may be configured to call and execute the one or more program codes to:
in the process of the unmanned vehicle flying in the environment, obtain the position of the target object in the environment sent by the unmanned vehicle, where the position is determined by the sensing data output by the unmanned vehicle according to the observation sensor configured by the unmanned vehicle to sense the target object;
send the position of the target object to another unmanned vehicle flying in the environment or send the position of the target object a second relay device to make the second relay device send the position of the target object to the another unmanned vehicle flying in the environment, such that the another unmanned vehicle adjusts the photographing direction of the photographing device on the another unmanned vehicle to face the target object according to the position of the target object.

In some embodiments, the observation sensor may include a photographing device, and the at least one processor may be configured to:
receive and display the image captured by the photographing device sent by the unmanned vehicle;
detect the user's target object selection operation on the displayed image, and determine the target object indication information according to the detected target object selection operation, where the target object indication information may include the position of the target object in the image; and
send the target object indication information to the unmanned vehicle such that the unmanned vehicle selects the target object in the environment.

In some embodiments, the at least one processor may be configured to:
receive and display the image captured by the photographing device sent by the unmanned vehicle;
receive the position of the target object in the image sent by the unmanned vehicle; and
display a mark indicating the position of the target object in the image on the displayed image.

In some embodiments, the observation sensor may include a ranging sensor. The unmanned vehicle may include a gimbal for mounting the ranging sensor and adjusting the observation direction of the ranging sensor. The at least one processor may be configured to:
detect the user's observation direction adjustment operation, and generate an observation direction adjustment instruction according to the detected observation direction adjustment operation; and
send the observation direction adjustment instruction to the unmanned vehicle such that the unmanned vehicle adjusts the observation direction of the distance sensor to face the target object according to the observation direction adjustment instruction.

In some embodiments, the unmanned vehicle may include a photographing device, and the at least one processor may be configured to:
receive and display the image captured by the photographing device and sent by the unmanned vehicle;
receive the position of the target object in the image sent by the unmanned vehicle, and display a mark indicating the position of the target object in the image on the displayed image, where the position of the target object in the image is determined by the unmanned vehicle according to the position of the target object; or,
determine the position of the target object in the image according to the position of the target object, and display a mark indicating the position of the target object in the image on the displayed image according to the position of the target object in the image.

In some embodiments, the second relay device may include at least one of a server and a control terminal of the another unmanned vehicle.

In some embodiments, the at least one processor may be configured to:
display the indication information of multiple candidate unmanned vehicles;
detect an unmanned vehicle selection operation of the user, and determine the indication information of the another unmanned vehicle selected by the user from the indication information of the multiple candidate unmanned vehicles according to the detected unmanned vehicle selection operation; and
send the position of the target object to the another unmanned vehicle corresponding to the selected indication information and flying in the environment or send the position of the target object to the second relay device to make the second relay device send the position of the target object to the another unmanned vehicle corresponding to the selected indication information flying in the environment.

In some embodiments, the position of the target object may be transmitted to the another unmanned vehicle flying in the environment such that the another unmanned vehicle controls the zoom of the photographing device according to the position of the target object; and/or,
the position of the target object may be transmitted to the another unmanned vehicle flying in the environment such that the another unmanned vehicle tracks the target object according to the position of the target object.

In some embodiments, the unmanned vehicle and the another unmanned vehicle may be unmanned vehicles bound to the same owner or workgroup.

As shown in FIG. 8, the present disclosure also provides a server 800. The server may include at least one memory 801 and at least one processor 802.

The at least one memory 801 may store one or more program codes.

The at least one processor 802 may be configured to call and execute the one or more program codes to:
obtain the position of the target object in the environment, where the position of the target object is determined by the sensing data output by the unmanned vehicle in the environment sensing the target object using the observation sensor on the unmanned vehicle;
send the position of the target object to another unmanned vehicle or send the position of the target object to a third relay device to make the third relay device send the position of the target object to another unmanned vehicle flying in the environment, such that the another unmanned vehicle adjusts the photographing direction of the photographing device on the another unmanned vehicle to face the target object according to the position of the target object.

In some embodiments, the at least one processor may be also configured to: determine the another unmanned vehicle bound to the same owner or workgroup as the unmanned vehicle;
When being used to send the position of the target object to the another unmanned vehicle or send the position of the target object to the third relay device to make the third relay device send the position of the target object to the another unmanned vehicle flying in the environment through the third relay device, the at least one processor may be configured to:
send the position of the target object to another unmanned vehicle bound to the unmanned vehicle or send the position of the target object to the third relay device to make the third relay device send the position of the target object to the another unmanned vehicle bound to the unmanned vehicle and flying in the environment.

In some embodiments, the at least one processor 802 may be configured to execute the one or more program codes to:
obtain the identity information of the unmanned vehicle;
determine the another unmanned vehicle bound to the unmanned vehicle according to the identity information.

In some embodiments, the at least one processor may be configured to:
determine the another unmanned vehicle in the environment from multiple candidate unmanned vehicles.

In some embodiments, the unmanned vehicle and the another unmanned vehicle may be unmanned vehicles bound to the same owner or workgroup.

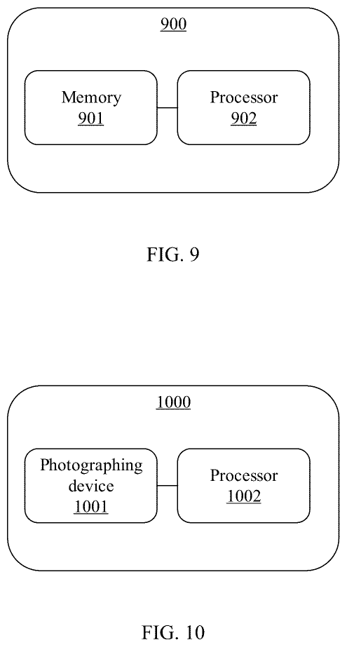

As shown in FIG. 9, the present disclosure also provides a control terminal 900 of an unmanned vehicle. The control terminal 900 may be the second control terminal as described above, and may include at least one memory 901 and at least one processor 902.

The at least one memory 901 may store one or more program codes.

The at least one processor 902 may be configured to call and execute the one or more program codes to:
obtain the position of the target object;
send the position of the target object to the unmanned vehicle in the environment, such that the unmanned vehicle adjusts the photographing direction of the photographing device on the unmanned vehicle to face the target object according to the position of the target object.

The position of the target object may be determined according to sensing data output by another unmanned vehicle flying in the environment using an observation sensor on the another unmanned vehicle to sense the target object.

In some embodiments, the at least one processor 902 may be configured to:
in response to obtaining the position of the target object, display a mark indicating the position of the target object according to the position of the target object; and/or,
in response to obtaining the position of the target object, display a mark indicating the orientation of the target object according to the position of the target object.

In some embodiments, the at least one processor may be configured to:
determine whether a preset sending condition is met in response to obtaining the position of the target object;
when the preset sending condition is met, send the obtained position of the target object to the unmanned vehicle; and
when the preset sending condition is not met, refuse to send the position of the target object to the unmanned vehicle.

In some embodiments, the at least one processor may be configured to:
determine whether the user's permission response operation is detected;
when the permission response operation is detected, determine that the preset sending condition is met; and
when the permission response operation is not detected, determine that the preset sending condition is not met.

In some embodiments, the at least one processor 902 may be configured to:
determine whether the unmanned vehicle meets a preset response condition, where the preset response condition includes at least one of whether the remaining power of the unmanned vehicle is greater than or equal to a preset power threshold, whether the distance between the unmanned vehicle and another unmanned vehicle or the target object is less than or equal to a preset distance threshold, or whether the unmanned vehicle is in flight;
when it is determined that the unmanned vehicle meets the preset response condition, determine that the preset sending condition is met; and
when it is determined that the unmanned vehicle does not meet the preset response condition, determine that the preset sending condition is not met.

In some embodiments, the at least one processor 902 may be configured to:
obtain the image captured by the photographing device of the unmanned vehicle and display the image; and
display the mark indicating the position of the target object in the image on the displayed image.

In some embodiments, the unmanned vehicle and the another unmanned vehicle may be unmanned vehicles bound to the same owner or workgroup.

As shown in FIG. 10, the present disclosure also provides an unmanned vehicle 1000. The unmanned vehicle 1000 may be the second unmanned vehicle as described above, and the unmanned vehicle 1000 may include a photographing device 1001 and a processor 1002.

The processor 1002 may be configured to:
obtain the position of the target object in an environment, where the position of the target object is determined according to the sensing data output by another unmanned vehicle in the environment using the observation sensor on the another unmanned vehicle to sense the target object;
adjust the photographing direction of the photographing device to face the target object according to the position of the target object.

In some embodiments, the at least one processor may be configured to:
track the target object according to the position of the target object.

In some embodiments, the unmanned vehicle 1000 may include at least one processor and at least one memory storing one or more instructions that, when executed by the at least one processor, causes the unmanned vehicle 1000 to perform a method consistent with the disclosure.

In some embodiments, the unmanned vehicle and the another unmanned vehicle may be unmanned vehicles bound to the same owner or workgroup.

The embodiments described in the present disclosure use unmanned vehicles as examples, but do not limit the scope of the present disclosure. The present disclosure is also applicable to any other suitable vehicles, such as movable platforms. Also, an unmanned vehicle consistent with the disclosure can be, e.g., an unmanned aerial vehicle.

In the present disclosure, the described related remote control devices and methods may be implemented in other ways. For example, the remote control device embodiments described above are only schematic. For example, the division of the modules or units is only a logical function division, and there may be other division methods in actual implementation. For example, multiple units or components may be combined or integrated into another system, or some features may be ignored or not executed. The mutual coupling or direct coupling or communication connection shown or discussed may be through some interfaces. The indirect coupling or communication connection of the remote control device or unit may be electrical, mechanical or other forms.

The units described as separate components may or may not be physically separated, and the components shown as units may or may not be physical units, that is, they may be located in one place, or they may be distributed on multiple network units. Some or all of the units may be selected according to actual needs to achieve the purpose of the present disclosure. In addition, the functional units in the various embodiments of the present disclosure may be integrated in a processing unit, or each unit may exist physically separately, or two or more units may be integrated in one unit. The above-mentioned integrated units may be implemented in the form of hardware or in the form of software functional units.

When the integrated unit is implemented in the form of a software functional unit and sold or used as an independent product, it may be stored in a computer-readable storage medium. Based on this understanding, the technical solution of the present disclosure, in essence, or all or part of the technical solution, may be embodied in the form of a software product, and the computer software product may be stored in a storage medium, including several instructions for a computer processor to execute all or part of the steps of the method described in each embodiment of the present disclosure. The aforementioned storage medium may include: a flash disk, a mobile hard disk, a read-only memory (ROM), a random access memory (RAM), a magnetic hard disk, an optical disk, or other media that can store program code.

In the present disclosure, terms such as “certain embodiments,” “one embodiment,” “some embodiments,” “illustrative embodiments,” “examples,” “specific examples” or “some examples,” mean that a specific feature, structure, material or characteristic described in connection with the embodiments or examples is included in at least one embodiment or example of the present disclosure. In the present disclosure, schematic representations of the above terms do not necessarily refer to the same embodiment or example. Furthermore, the specific features, structures, materials or characteristics described may be combined in any suitable manner in any one or more embodiments or examples.

Some or all aspects of the control method (or any other processes described herein, or variations and/or combinations thereof) may be performed by one or more processors onboard the unmanned vehicle, a payload of the unmanned vehicle (e.g., an imaging device), a control terminal, and/or a server. Some or all aspects of the control method (or any other processes described herein, or variations and/or combinations thereof) may be performed under the control of one or more computer/control systems configured with executable instructions and may be implemented as code (e.g., executable instructions, one or more computer programs or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory. The order in which the operations are described is not intended to be construed as a limitation, and any number of the described operations may be combined in any order and/or in parallel to implement the processes.

Various embodiments have been described to illustrate the operation principles and exemplary implementations. Those skilled in the art would understand that the present disclosure is not limited to the specific embodiments described herein and that various other obvious changes, rearrangements, and substitutions will occur to those skilled in the art without departing from the scope of the present disclosure. Thus, while the present disclosure has been described in detail with reference to the above described embodiments, the present disclosure is not limited to the above described embodiments, but may be embodied in other equivalent forms without departing from the scope of the present disclosure.

What is claimed is:

1. A control method comprising:
obtaining sensing data output by an observation sensor of a movable platform when sensing a target object in an environment;
determining a position of the target object based on the sensing data; and
sending the position of the target object to another movable platform moving in the environment, or to a relay device for the relay device to send the position of the target object to the another movable platform.

2. The method according to claim 1, wherein:
the observation sensor includes a photographing device;
obtaining the sensing data includes obtaining an image output by the photographing device when photographing the target object; and
determining the position of the target object includes:
determining a position of the target object in the image; and
determining the position of the target object based on the position of the target object in the image.

3. The method according to claim 2, wherein the target object is selected by a user when performing a target object selection operation on a control terminal displaying the image collected by the photographing device.

4. The method according to claim 2, further comprising:
sending the image to a control terminal for the control terminal to display the image; and
sending the position of the target object in the image to the control terminal for the control terminal to display a mark indicating the position of the target object in the image on the displayed image.

5. The method according to claim 1, wherein:
the observation sensor includes a ranging sensor; and
obtaining the sensing data includes:
obtaining a distance to the target object output by the ranging sensor and an observation attitude of the ranging sensor; and
determining the position of the target object according to the distance to the target object and the observation attitude.

6. The method according to claim 5, wherein the ranging sensor includes a receiver for transmitting a ranging signal and receiving the ranging signal reflected by the target object.

7. The method according to claim 5,
wherein the movable platform includes a gimbal for installing the ranging sensor and adjusting the observation direction of the ranging sensor;
the method further comprising:
obtaining an observation direction adjustment instruction sent by a control terminal; and controlling the gimbal to adjust the observation direction of the ranging sensor toward the target object according to the observation direction adjustment instruction.

8. The method according to claim 5,
wherein the movable platform includes a photographing device;
the method further comprising:
sending an image captured by the photographing device to a control terminal of the movable platform for the control terminal to display the image; and
performing one of:
determining a position of the target object in the image according to the position of the target object and sending the position of the target object in the image to the control terminal for the control terminal to display a mark indicating the position of the target object in the image on the displayed image; or
sending the position of the target object to the control terminal for the control terminal to determine the position of the target object in the image according to the position of the target object and display the mark indicating the position of the target object in the image on the displayed image.

9. The method according to claim 1, wherein the relay device includes at least one of a control terminal corresponding to the movable platform, a server, or a control terminal corresponding to the another movable platform.

10. The method according to claim 1, wherein:
the position of the target object is transmitted to the another movable platform for the another movable platform to control zoom of a photographing device of the another movable platform according to the position of the target object; and/or
the position of the target object is transmitted to the another movable platform for the another movable platform to track the target object according to the position of the target object.

11. The method according to claim 1, wherein:
the movable platform and the another movable platform are bound to a same owner or workgroup.

12. The method according to claim 1, further comprising:
controlling the another movable platform to adjust a photographing direction of a photographing device of the another movable platform to face the target object, according to the position of the target object.

13. A control method of a server comprising:
obtaining a position of a target object in the environment, the position of the target object being determined according to sensing data output by a movable platform in the environment sensing the target object using an observation sensor of the movable platform; and
sending the position of the target object to another movable platform moving in the environment, or to a relay device to forward the position of the target object to the another movable platform through the relay device.

14. The method according to claim 13, further comprising:
controlling the another movable platform to adjust a photographing direction of a photographing device of the another movable platform to face the target object, according to the position of the target object.

15. The method according to claim 13, further comprising:
determining the another movable platform that is bound to a same owner or workgroup as the movable platform;
wherein sending the position of the target object to the another movable platform or to the relay device includes:
sending the position of the target object to the another movable platform bound to the movable platform or sending the position of the target object to the relay device to forward, through the relay device, the position of the target object to the another movable platform bound to the movable platform.

16. The method according to claim 13, wherein:
determining the another movable platform bound to the same owner or workgroup as the movable platform includes:
obtaining identity information of the movable platform; and
determining the another movable platform bound to the movable platform according to the identity information.

17. The method according to claim 13, further comprising:
determining the another movable platform in the environment from a plurality of candidate movable platforms.

18. The method according to claim 13, wherein the movable platform and the another movable platform are bound to a same owner or workgroup.

19. A movable platform comprising:
at least one observation sensor;
at least one processor; and
at least one memory storing one or more instructions that, when executed by the at least one processor, cause the movable platform to:
obtain sensing data output by the at least one observation sensor when sensing a target object in the environment during a process of the movable platform moving in the environment;
determine a position of the target object based on the sensing data; and
send the position of the target object to another movable platform moving in the environment, or send the position of the target object to a relay device for the relay device to send the position of the target object to the another movable platform.

20. The movable platform according to claim 19, wherein:
the at least observation sensor includes a photographing device, and the one or more instructions, when executed by the at least one processor, further cause the at least one processor to:
obtain an image output by the photographing device;
determine a position of the target object in the image; and
determine the position of the target object based on the position of the target object in the image; or
the at least one observation sensor includes a ranging sensor, and the one or more instructions, when executed by the at least one processor, further cause the at least one processor to:
obtain a distance to the target object output by the ranging sensor and an observation attitude of the ranging sensor; and
determine the position of the target object according to the output distance to the target object and the observation attitude.
